(19) United States
(12) Patent Application Publication
(10) Pub. No.: US 2021/0173614 A1
(43) Pub. Date: Jun. 10, 2021

(54) ARTIFICIAL INTELLIGENCE DEVICE AND METHOD FOR OPERATING THE SAME

(71) Applicant: LG ELECTRONICS INC., Seoul (KR)

(72) Inventors: Wonho SHIN, Seoul (KR); Jichan MAENG, Seoul (KR)

(73) Assignee: LG ELECTRONICS INC., Seoul (KR)

(21) Appl. No.: 16/801,035

(22) Filed: Feb. 25, 2020

(30) Foreign Application Priority Data
Dec. 5, 2019 (KR) 10-2019-0160620

(51) Int. Cl. G06F 3/16; G06K 9/00; G06N 3/08; G06N 3/04

(52) U.S. Cl. CPC G06F 3/165; G06K 9/00711; G06K 9/6218; G06N 3/04; G06N 3/08

(57) ABSTRACT

Provided is an artificial intelligence device which identifies a plurality of objects contained in the video, acquires one or more objects, which are capable of outputting an audio, of the plurality of identified objects, displays one or more volume adjustment items for adjusting a volume of the audio output from each of the one or more acquired objects on a display, and adjusts the volume of the audio output from the corresponding object according to an operation command of each of the volume adjustment items.

### CROSS-REFERENCE TO RELATED APPLICATIONS

Pursuant to 35 U.S.C. § 119(a), this application claims the benefit of earlier filing date and right of priority to Korean Patent Application No. 10-2019-0160620, filed on Dec. 5, 2019, the contents of which are all hereby incorporated by reference herein in its entirety.

### BACKGROUND

The present disclosure relates to an artificial intelligence device, and more particularly, to an artificial intelligence device that recognizes an object with a video and controls an audio output of the recognized object.

When playing a video, most of objects contained in the video and the person who wants to hear by zooming in to the sound are actually limited.

That is, after recording a sound source including a video by using a product capable of acquiring a multi-channel sound source including a mobile device, when the corresponding video is played, a user's need to listen more closely to a specific target sound among various sound sources of the video occurs.

If the user provides a means that focuses on an audio generated from a specific object among the plurality of objects contained in the image, the user may watch the video more usefully.

### SUMMARY

Embodiments provide a function of selecting one or more objects capable of audio zoom-in among a plurality of objects on a playback screen when a video is played so as to allow a user to select the objects.

Embodiments also provide a function of distinguishing a plurality of objects contained in a video by using an image recognition technique, distinguishing one or more objects capable of generating sound among the plurality of objects, and audio zoom-in of the one or more distinguished objects.

In one embodiment, an artificial intelligence device may identify a plurality of objects contained in the video, acquires one or more objects, which are capable of outputting an audio, of the plurality of identified objects, display one or more volume adjustment items for adjusting a volume of the audio output from each of the one or more acquired objects on a display, and adjust the volume of the audio output from the corresponding object according to an operation command of each of the volume adjustment items.

In another embodiment, an artificial intelligence device may control one or more speakers to increase in output of an audio generated by a selected object among one or more objects capable of outputting the audio.

### Effects of the Invention

According to the exemplary embodiment, when the user plays the video, the user may focus on the desired object to watch the video, thereby feeling the improved video viewing experience.

In addition, the user may conveniently adjust the audio output of the desired object when playing the video.

The details of one or more embodiments are set forth in the accompanying drawings and the description below. Other features will be apparent from the description and drawings, and from the claims.

### BRIEF DESCRIPTION OF THE DRAWINGS

FIG. 1 is a view of an AI device according to an embodiment.

FIG. 2 is a view of an AI server according to an embodiment.

FIG. 3 is a view of an AI system according to an embodiment.

FIG. 4 is a view of an AI device according to another embodiment.

FIG. 5 is a flowchart for explaining a method for operating an artificial intelligence device according to an embodiment.

FIGS. 6 and 7 are views for explaining a process of training an object detection model according to an embodiment.

FIG. 8 is a view illustrating a process of training an object identification model according to an embodiment.

FIG. 9 is a view illustrating an example of identifying an utterable object and adjusting an audio output of the identified object when playing a video according to an embodiment.

FIG. 10 is a view illustrating a process of adjusting an audio output of a selected object among a plurality of objects contained in a video according to an embodiment.

FIG. 11 is a flowchart illustrating a method for adjusting an audio volume of an object according to an embodiment.

FIG. 12 is a view illustrating an example of clustering (grouping) a plurality of objects when the plurality of utterable objects contained in a video are provided according to an embodiment.

FIG. 13 is a view illustrating a result of clustering the plurality of objects into a plurality of clusters according to an embodiment.

FIG. 14 is a view illustrating an example of clustering a plurality of objects contained in the video according to an embodiment.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of training an artificial neural network in a state in which a label for learning data is given, and the label may mean the correct answer (or result value) that the artificial neural network must infer when the learning data is input to the artificial neural network. The unsupervised learning may refer to a method of training an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

In this case, the self-driving vehicle may be regarded as a robot having a self-driving function.

<eXtended Reality (XR)>

Extended reality is collectively referred to as virtual reality (VR), augmented reality (AR), and mixed reality (MR).

The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

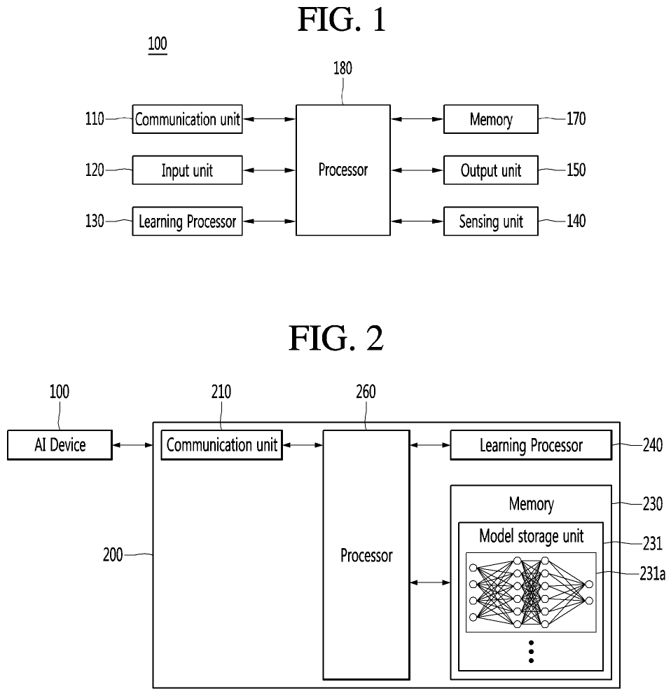

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing device 140, an output device 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

In this case, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used if an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing device 140 may acquire at least one of internal information about the AI device 100, ambient environment information about the AI device 100, and user information by using various sensors.

Examples of the sensors included in the sensing device 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output device 150 may generate an output related to a visual sense, an auditory sense, or a haptic sense.

on, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. In this case, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

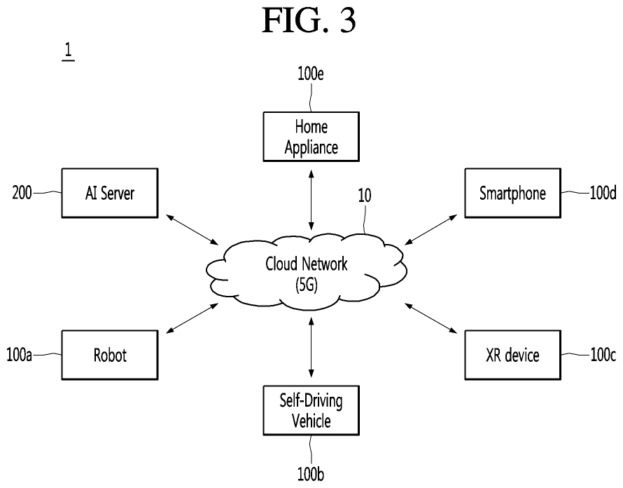

FIG. 3 is a view of an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the accommodated input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model provided as at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be accommodated to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the path and the travel plan, or may determine the operation.

Like the robot 100a, the self-driving vehicle 100b may use the sensor information acquired from at least one sensor among the lidar, the radar, and the camera so as to determine the travel path and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

In this case, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel path and the travel plan, and may control the driving device such that the self-driving vehicle 100b travels along the determined travel path and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving device based on the control/interaction of the user. In this case, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

In this case, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot subjected to control/interaction in an XR image. In this case, the robot 100a may be separated from the XR device 100c and interwork with each other.

If the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user may confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving vehicle 100b, to which the XR technology is applied, may refer to a self-driving vehicle having a means for providing an XR image or a self-driving vehicle subjected to control/interaction in an XR image. Particularly, the self-driving vehicle 100b that is subjected to control/interaction in the XR image may be distinguished from the XR device 100c and interlocked with each other.

The self-driving vehicle 100b having the means for providing the XR image may acquire the sensor information from the sensors including the camera and output the generated XR image based on the acquired sensor information. For example, the self-driving vehicle 100b may include a HUD to output an XR image, thereby providing a passenger with a real object or an XR object corresponding to an object in the screen.

In this case, if the XR object is output to the HUD, at least part of the XR object may be outputted so as to overlap the actual object to which the passenger's gaze is directed. Meanwhile, if the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

If the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

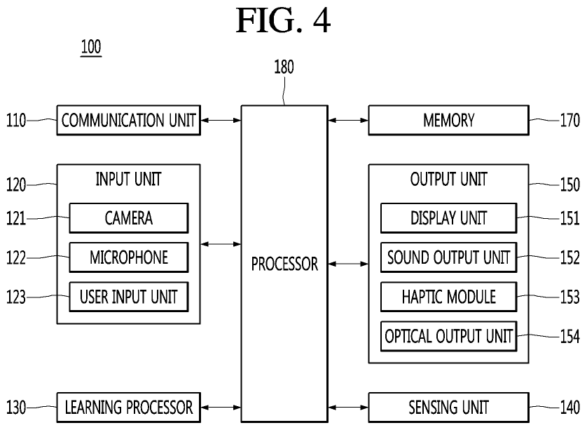

FIG. 4 illustrates an AI device 100 according to an embodiment of the present disclosure.

The redundant repeat of FIG. 1 will be omitted below.

Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the mobile terminal 100 may include at least one camera 121 in order for inputting image information.

The camera 121 processes image frames such as a still image or a video acquired by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and if information is inputted through the user input unit 123, the processor 180 may control an operation of the mobile terminal 100 to correspond to the inputted information.

The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen.

The output device 150 may include at least one of a display unit 151, a sound output module 152, a haptic module 153, or an optical output module 154.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the mobile terminal 100 and a user, and an output interface between the mobile terminal 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user may feel. A representative example of a haptic effect that the haptic module 153 generates is vibration.

The optical output module 154 outputs a signal for notifying event occurrence by using light of a light source of the mobile terminal 100. An example of an event occurring in the AI device 100 includes message reception, call signal reception, missed calls, alarm, schedule notification, e-mail reception, and information reception through an application.

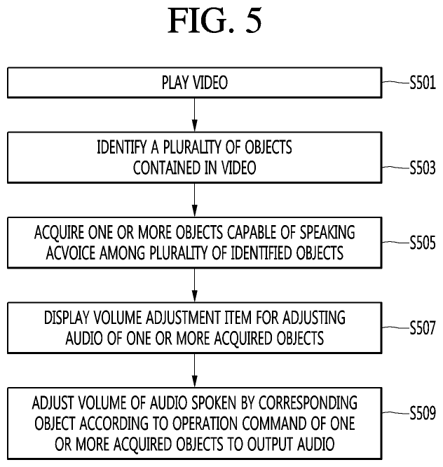

FIG. 5 is a flowchart for explaining a method for operating an artificial intelligence device according to an embodiment.

Referring to FIG. 5, a processor 180 of the artificial intelligence apparatus 100 plays a video through the display unit 151 (S501).

The processor 180 may separate a video and a sound source corresponding to the video to store the video and the sound source in the memory 170.

The processor 180 of the artificial intelligence device 100 identifies a plurality of objects contained in the video (S503).

The processor 180 may identify the plurality of objects from image data at a specific time point of the video or from image data in a specific playback section.

The processor 180 may detect the plurality of objects from the video and identify each of the plurality of detected objects based on an object detection model.

The object detection model may be a model for detecting the plurality of objects from an image.

The object detection model may be an artificial neural network based model trained by a deep learning algorithm or a machine learning algorithm.

The object detection model may be a model that is trained by the running processor 130 of the artificial intelligence device 100 and stored in the memory 170.

For another example, the object detection model may be a model trained by the running processor 240 of the AI server 200 and transmitted from the AI server 200 to the artificial intelligence device 100.

An example of detecting the plurality of objects from the image using the object detection model will be described with reference to the following drawings.

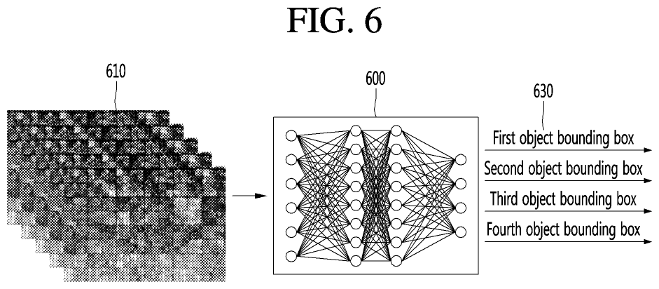

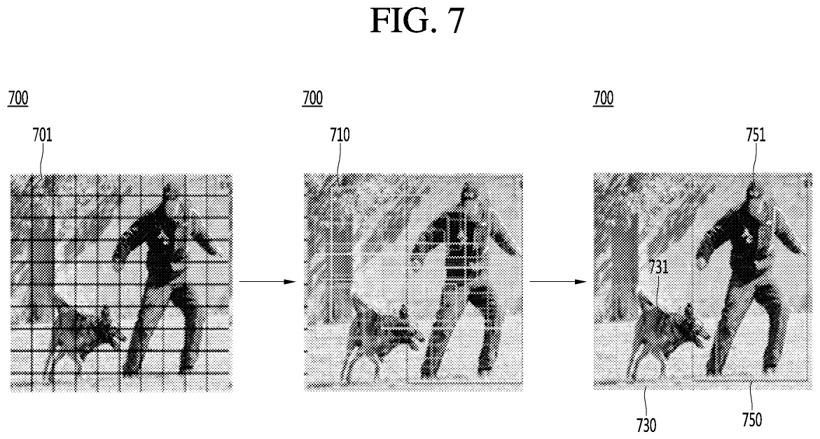

FIGS. 6 and 7 are views for explaining a process of learning the object detection model according to an embodiment.

Referring to FIG. 6, the object detection model 600 uses a training image data set 610 including a plurality of image data and acquires an object bounding box set 630 including a plurality of objects from each training image data.

The object bounding box set 630 may be a set of bounding boxes containing an object.

The object detection model 600 may detect the plurality of objects from the image data by using a YOLO (You Only Look Once) algorithm.

The YOLO (You Only Look Once) algorithm may be constituted by a plurality of CNNs.

The YOLO (You Only Look Once) algorithm will be described with reference to FIG. 7.

The YOLO (You Only Look Once) algorithm may include a grid division process, a prediction process, a reliability calculation process, and an object selection process.

The grid division process may be a process of dividing the image data 700 into a plurality of grids. The plurality of grids 701 may be the same size.

The prediction process may be a process of predicting the number of bounding boxes 710 designated in a predefined shape with respect to a center of the grid for each grid.

The bounding box designated as a predefined shape may be generated from data by the K-average algorithm and may contain dictionary information on the size and shape of the object.

Each of the bounding boxes may be designed to detect objects having different sizes and shapes.

Each of the bounding boxes may represent a shape or boundary of the object.

The reliability calculation process may be a process of calculating reliability of the bounding box according to whether the object is included in each of the obtained bounding boxes or only the background is alone.

The object determination process may be a process of determining that an object exists in a bounding box having reliability equal to or greater than a preset value according to the reliability calculation process.

The plurality of bounding boxes 730 and 750 included in the image data 700 may be extracted through the object determination process.

FIG. 5 will be described again.

The processor 180 may acquire identification information of each of the objects from the plurality of bounding boxes extracted through the object detection model 600.

The processor 180 may identify an object existing in the bounding box from the image data corresponding to each of the bounding boxes using the object identification model.

The object identification model may be a learned artificial neural network based model using the deep learning algorithm or the machine learning algorithm.

The object identification model may be a model learned through supervised learning.

The object identification model may be a model for inferring identification information of the object from image data. The identification information of the object may be information for identifying the object such as a name of the object, an identifier of the object, and the like.

The object identification model may be a model that outputs identification information of the object using training data sets including the training image data and labeling data labeled in the training image data as input data.

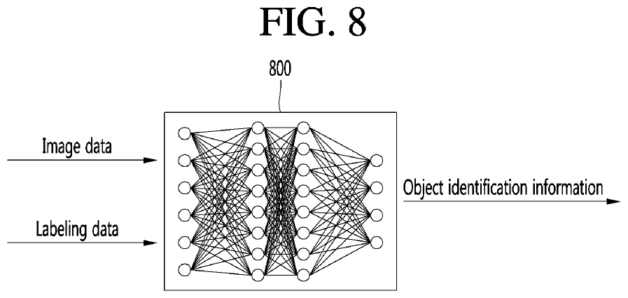

FIG. 8 is a view illustrating a process of training an object identification model according to an embodiment.

Referring to FIG. 8, the object identification model 800 may infer object identification information using the training data set including the training image data and the labeling data labeled thereon.

The labeling data is correct answer data and may be object identification information.

The object identification model 800 may be trained to minimize a cost function corresponding to a difference between the labeling data and the object identification information.

The cost function of the object identification model 800 may be expressed as a squared mean of a difference between the label for the object identification information corresponding to each image data and the object identification information inferred from each image data.

When an input feature vector is extracted from the training image data and is input, the object identification result is output as a target feature vector, and the object identification model 800 is learned to minimize a loss function corresponding to a difference between the output target feature vector and the labeled object identification information.

The object identification model 800 may be trained by the running processor 130 of the artificial intelligence device 100 or the running processor 240 of the AI server 200 and mounted on the artificial intelligence device 100.

The object identification model 800 may determine first object identification information from first image data corresponding to the first bounding box 730 illustrated in FIG. 7. For example, the first object identification information may be a dog.

The object identification model 800 may determine second object identification information from second image data corresponding to the second bounding box 750. For example, the second object identification information may be a person.

As described above, it may be identified which object is the object from the image data through the object identification model 800.

FIG. 5 will be described again.

The processor 180 of the artificial intelligence device 100 acquires one or more objects capable of speaking a voice among the identified plurality of objects (S505).

The processor 180 may determine whether the corresponding object is an object capable of speaking a voice based on the object identification information acquired through the object identification model 800.

The processor 180 may store an object list representing the object capable of speaking a voice in the memory 170. For example, the object list may include objects capable of outputting a voice, like animals such as people, cars, dogs, and cats.

The processor 180 may compare the object list stored in the memory 170 with the object identification information to determine whether the identified object is an utterable object from the video.

As the result of the comparison, when the object identification information is included in the object list, the processor 180 may determine that the identified object is the utterable object.

As the result of the comparison, when the object identification information is not included in the object list, the processor 180 may determine that the identified object is an object that is not spoken.

The processor 180 of the artificial intelligence device 100 displays a volume adjustment item for adjusting the audio volume of the one or more obtained objects on the display unit 151 (S507).

The processor 180 may display the volume adjustment item for adjusting the volume of an audio output by the utterable object at a position adjacent to the object.

When the processor 180 receives a command for adjusting the volume of the audio of the object, the processor 180 may display the volume adjustment item on the display unit 151.

The command for adjusting the audio volume of the object may be a voice command such as <adjust object sound!> or a command for selecting an utterable object.

The processor 180 of the artificial intelligence device 100 adjusts and outputs the volume of the audio spoken by the corresponding object according to an operation command of the volume adjustment item (S509).

The processor 180 may control the sound output unit 152 to adjust the volume of the audio spoken by the object according to the manipulation command of the volume adjustment item.

The sound output unit 152 may include one or more speakers.

The processor 180 may control the one or more speakers to adjust an output of the audio spoken by the object according to the operation command.

The processor 180 may control the one or more speakers to increase in volume of an audio output by an object selected by the user.

The processor 180 may adjust the output of the speaker corresponding to a position of the object by tracking a position of the selected object.

For example, when the object is disposed at a left side, the processor 180 may increase in audio output of the speaker disposed at the left side and decrease in audio output of the speaker disposed on a right side.

An embodiment of adjusting the audio volume of the object will be described with reference to the following drawings.

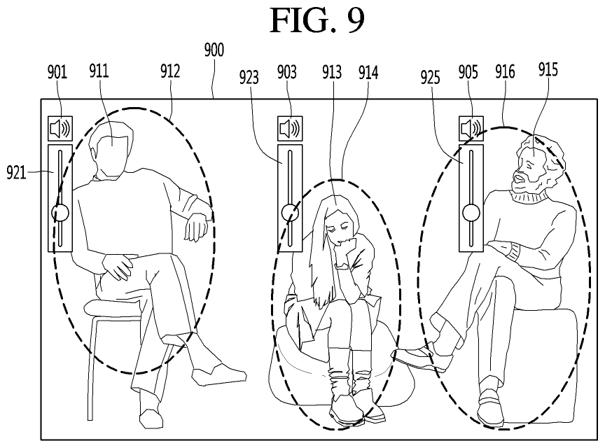

FIG. 9 is a view illustrating an example of identifying the utterable object and adjusting the audio output of the identified object when playing the video according to an embodiment.

FIG. 9 illustrates a video 900 being played through the display unit 151 of the artificial intelligence device 100.

The processor 180 may identify a plurality of spoken objects 911, 913, and 915 contained in the video 900 by using the object detection model 600 and the object identification model 800.

The plurality of objects 911, 913, and 915 may all be humans.

The processor 180 may display indicators 912, 914, and 916 for distinguishing each of the plurality of objects 911, 913, and 915.

That is, the first indicator 912 is for distinguishing the first object 911, the second indicator 914 is for distinguishing the second object 913, and the third indicator 916 is for distinguishing the third object 915.

The processor 180 may display a volume icon indicating that the audio output of the object is adjustable and a volume adjustment item for adjusting the audio output of the object, which are adjacent to each of the plurality of objects 911, 913, and 915.

For example, the first volume icon 901 and the first volume adjustment item 921 may be displayed near the first object 911. The first volume adjustment item 921 may be a bar-shaped item for adjusting the volume of audio output from the first object 911 according to a user's manipulation command.

Similarly, the second volume icon 903 and the second volume adjustment item 923 may be displayed near the second object 913. The third volume icon 905 and the third volume control item 925 may be displayed near the third object 915.

The processor 180 may activate or deactivate an output of an audio spoken by the object according to the selection of the volume icon. For example, when the second volume icon 903 that is in the activated state is selected, the processor 180 may mute the output of the audio spoken by the second object 913.

When any one of the plurality of objects 911, 913, and 915 is selected, only an indicator, a volume icon, and a volume control item, which correspond to the selected object, may be displayed, and the indicator, volume icon, and volume adjustment item, which correspond to the remaining objects, may disappear.

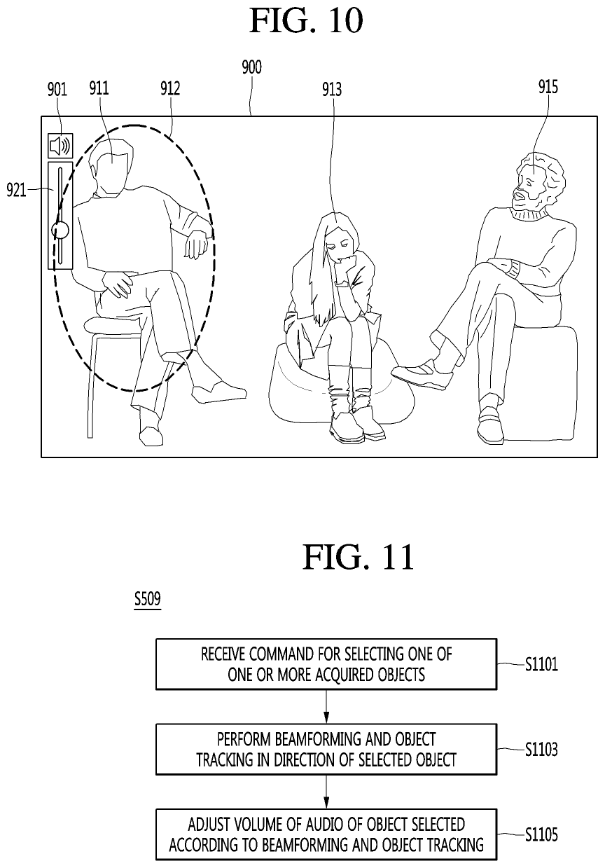

FIG. 10 is a view illustrating a process of adjusting an audio output of a selected object among the plurality of objects contained in the video according to an embodiment.

In FIG. 9, when the processor 180 receives a command for selecting the first object 911, as illustrated in FIG. 10, only the first indicator 912, the first volume icon 901, and the first volume adjustment item 921, which correspond to the first object 911, may be displayed, and the indicators, the volume icons, and the volume adjustment items, which correspond to the remaining objects 913 and 915 may not be displayed.

The user may manipulate the adjustment bar included in the first volume adjustment item 921 to adjust the volume of the audio spoken by the first object 911.

In another embodiment, when the first object 911 is selected, the processor 180 enlarges the size of the first object 911 while controlling the volume of the audio spoken by the first object 911 to play the video 900.

As described above, according to an embodiment, the user may watch a video by focusing on a desired object when playing the video. In addition, the user may conveniently adjust the audio output of the desired object when playing the video.

Meanwhile, in order to adjust the audio output of a selected object among the plurality of utterable objects when playing the video, a method of distinguishing the audio output for each object is required. This is because a position of the object may change with time when the video is played.

FIG. 11 is a flowchart illustrating a method for adjusting an audio volume of an object according to an embodiment.

FIG. 11 may be a view for describing an operation S509 of FIG. 5 in detail.

The processor 180 of the artificial intelligence device 100 receives a command for selecting any one of one or more utterable objects (S1101).

The user may select an object by touching the object inside the indicator.

The processor 180 of the artificial intelligence device 100 performs beamforming and object tracking in a direction of the selected object according to the received command (S1103).

The input unit 120 of the artificial intelligence device 100 may include a plurality of microphones.

The beamforming may be a signal processing technique for receiving an audio signal corresponding to the selected object among the audio signals received by each of the one or more microphones in comparison with other signals.

That is, the processor 180 may reinforce the audio signal output by the selected object by using the beamforming.

The object tracking may be a technique for continuously tracking an object of interest from the video.

After the object is selected, the processor 180 may compare the previous frame with the current frame and track the corresponding object when the selected object is included in the same frame.

The processor 180 of the artificial intelligence device 100 adjusts and outputs an audio volume of the selected object according to the beamforming and the object tracking (S1105).

The processor 180 may adjust a degree (or intensity) of the beamforming by using the object tracking according to reception of an operation command for the volume adjustment item. Accordingly, the output of the audio volume of the object selected by the user may be adjusted.

According to another embodiment, the processor 180 may classify an audio signal output by the object by using prior information of the object.

The dictionary information of the object may include one or more of the frequency distribution according to types of object and characteristics of the object.

The types of object may indicate whether the object is a human, an animal, or a machine.

The characteristics of the object may be a gender indicating whether the object is a man or a woman.

The characteristics of the object may indicate whether the object is a cat, a dog, or a horse when the object is an animal.

The processor 180 may separate sound source signals corresponding to each object from sound source signals of the video by using dictionary information of each of the plurality of objects.

When the plurality of objects in the video are disposed at the same position or direction, and it is difficult to distinguish the audio of the objects by the above methods, a known sound separation technique may be used.

The known sound separation techniques may be any one of source separation, blind signal separation, and blind source separation.

Each sound separation technique may be a technique of separating a plurality of sound signals from frequency characteristics of each of the plurality of sound signals.

When recognizing the object through the video, a number of objects for audio zoom-in may be recognized according to the number of frames constituting the video. When the user selects the recognized object, an image and audio to which the audio zoom-in is applied should be output for each selected object. However, actually, when the objects are in close proximity to each other, the user may not notice a big difference.

Therefore, according to an embodiment, it is necessary to cluster the objects in close proximity into one group.

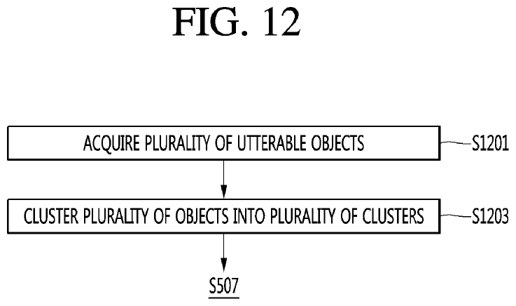

FIG. 12 is a view illustrating an example of clustering (grouping) the plurality of objects when the plurality of utterable objects contained in the video are provided according to an embodiment.

The processor 180 of the artificial intelligence device 100 acquires a plurality of utterable objects from the video (S1201).

For this, an embodiment related to an operation S503 illustrated in FIG. 5 may be applied to FIG. 12.

That is, the processor 180 may identify the plurality of objects from the video using the object detection model 600 and the object identification model 800.

The processor 180 of the artificial intelligence device 100 clusters the plurality of acquired objects into a plurality of clusters (S1203).

One cluster may form one cluster.

In an embodiment, the processor 180 may cluster the plurality of objects into a plurality of clusters by using a K-nearest neighbor algorithm.

The K-nearest neighbor algorithm may be an algorithm for clustering K objects disposed in the neighbor in the cluster in a feature space.

The processor 180 may adjust the number of objects included in one cluster by setting a threshold at a distance between the objects in one cluster using the K-nearest neighbor algorithm.

The feature space may be a space for vectorizing each object to indicate at which each object is disposed.

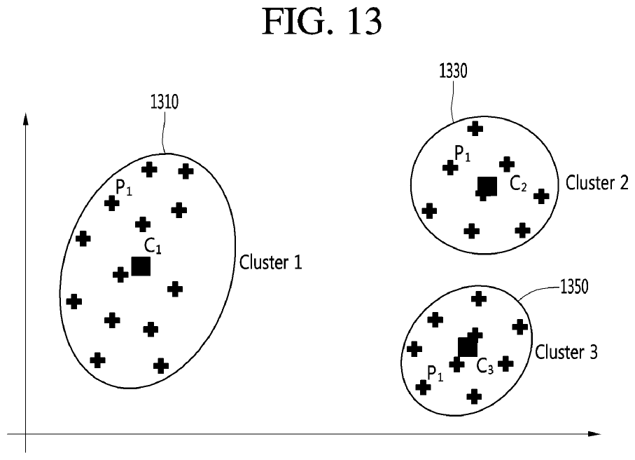

FIG. 13 is a view illustrating a result of clustering the plurality of objects into the plurality of clusters according to an embodiment.

Referring to FIG. 13, a plurality of objects included in one scene are clustered into three clusters 1310, 1330, and 1350.

Each cluster may be treated as an object. That is, the user may select the object included in the cluster and adjust the audio volume of the selected object according to the selection of the cluster and the audio adjustment of the cluster.

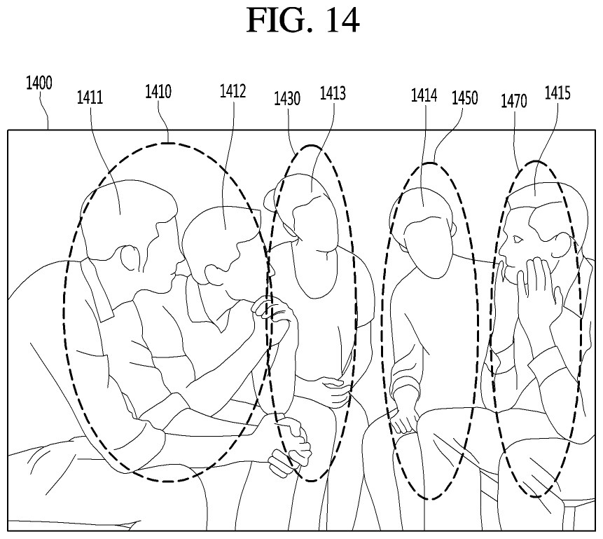

FIG. 14 is a view illustrating an example of clustering the plurality of objects contained in the video according to an embodiment.

Referring to FIG. 14, the processor 180 of the artificial intelligence device 100 plays the video 1400 through the display unit 151.

The processor 180 classifies the plurality of utterable objects 1411 to 1415 included in the video 1400 into a plurality of clusters 1410, 1430, 1450, and 1470 using the K-nearest neighbor algorithm.

The processor 180 may recognize each of the plurality of clusters 1410, 1430, 1450, and 1470 as one object.

That is, the first object 1411 and the second object 1412 belonging to the first cluster 1410 may be treated as one object.

When the first cluster 1410 is selected, the processor 180 may determine that the first object 1411 and the second object 1412 are selected.

A volume adjustment item (not shown) for adjusting a volume of audio output from the cluster and a volume icon (not shown) indicating that the volume is adjustable may be displayed at adjacent positions of each cluster.

The embodiment of FIG. 9 will be described by deriving the volume icon and the volume control item.

The processor 180 may mute the audio output by the objects in the cluster through a manipulation command of the volume icon.

The processor 180 may increase or decrease in volume of the audio output by the object in the cluster as the operation command of the volume adjustment item is received.

When the first cluster 1410 is selected, the processor 180 may enlarge and play the first object 1411 and the second object 1413 included in the first cluster 1410.

When there are a plurality of objects in one cluster, one of the source separation, the blind signal separation, and the blind source separation, which are the beamforming method or the known sound separation technique described in FIG. 11, may be used as the audio output by each object.

As described above, according to an embodiment, when the plurality of objects are disposed in the vicinity of the video, the plurality of objects are clustered into the one group, and as the audio is output, the user may watch the video while focusing on the corresponding objects.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices. Also, the computer may include the processor 180 of the artificial intelligence server.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An artificial intelligence device comprising:
a memory configured to store an object list representing utterable objects;
one or more speakers configured to output audio;
a display configured to display a video; and
one or more processors configured to:
acquire object identification information of each of a plurality of objects identified to be contained in the video,
acquire one or more objects capable of audio output from among the identified plurality of objects,
cause, on a display, a display of one or more volume adjustment items that correspond to adjusting an audio volume of a particular object from the acquired one or more objects capable of audio output,
adjust the audio volume of the output audio for at least one specific object from the acquired one or more objects according to an operation command of a respective volume adjustment item from among the one or more volume adjustment items corresponding to the at least one specific object, and
determine that an identified object from the identified plurality of objects is an utterable object from the video based at least in part on determining that the acquired object identification information is included in the object list through a comparison of the object list with the acquired object identification information.

2. The artificial intelligence device of claim 1, wherein the plurality of objects are detected based at least in part on using an object detection model, and the one or more processors are further configured to acquire the identification information of each of the plurality of objects by using an object identification model.

3. The artificial intelligence device of claim 2, wherein the object detection model and the object identification model are trained by deep learning algorithms,
the object detection model is configured to extract a bounding box that represents a shape of the particular object based on image data corresponding to a frame from the video, and
the object identification model is configured to acquire the identification information by identifying the particular object contained in the extracted bounding box.

4. (canceled)

5. The artificial intelligence device of claim 1, wherein the one or more processors are further configured to cause, on the display, a display of one or more volume icons representing adjustment of the audio volume from the acquired one or more objects.

6. The artificial intelligence device of claim 5, wherein the one or more processors are further configured to mute the audio output from the at least one specific object according to a command selecting a corresponding volume icon from the one or more volume icons.

7. The artificial intelligence device of claim 1, wherein the one or more processors are further configured to control audio outputs of the one or more speakers to correspond to a position of a selected object of the acquired one or more objects according to the operation command of the respective volume adjustment item.

8. The artificial intelligence device of claim 1, wherein the one or more objects are acquired by:
acquiring a plurality of the one or more objects capable of outputting audio,
clustering the acquired plurality of the one or more objects into a plurality of clusters, and
controlling audio output contained in a selected cluster from the plurality of clusters.

9. A method for operating an artificial intelligence device, the method comprising:
identifying a plurality of objects contained in a video;
acquiring object identification information of each of a plurality of objects identified to be contained in the video;
acquiring one or more objects capable of audio output from among the identified plurality of objects;
displaying one or more volume adjustment items that correspond to adjusting an audio volume of a particular object from the acquired one or more objects capable of audio output on a display;
adjusting, on one or more speakers, the audio volume of the output audio for at least one specific object from the acquired one or more objects according to an operation command of a respective volume adjustment item from among the one or more volume adjustment items corresponding to the at least one specific object; and
determine that an identified object from the identified plurality of objects is an utterable object from the video based at least in part on determining that the acquired object identification information is included in an object list through a comparison of the object list with the acquired object identification information.

10. The method of claim 9, wherein the plurality of objects are detected based at least in part on using an object detection model; and the method further comprising
acquiring the identification information of each of the plurality of objects by using an object identification model.

11. The method of claim 10, wherein the object detection model and the object identification model correspond to a model trained by deep learning algorithms,
the object detection model is configured to extract a bounding box that represents a shape of the particular object based on image data corresponding to a frame from the video, and
the object identification model is configured to acquire the identification information by identifying the particular object contained in the extracted bounding box.

12. (canceled)

13. The method of claim 9, further comprising displaying one or more volume icons representing adjustment of the audio volume from the acquired one or more objects.

14. The method of claim 13, further comprising muting the audio output from the at least one specific object according to a command selecting a corresponding volume icon from the one or more volume icons.

15. The method of claim 9, wherein adjusting the audio volume further comprises controlling audio outputs of the one or more speakers to correspond to a position of a selected object from the acquired one or more objects according to the operation command of the respective volume adjustment item.

16. The method of claim 9, wherein the one or more objects are acquired by:
acquiring a plurality of the one or more objects capable of outputting audio; and
clustering the acquired plurality of the one or more objects into a plurality of clusters, and
controlling, in one or more speakers, audio output contained in a selected cluster from the plurality of clusters.

17. A machine-readable non-transitory medium having stored thereon machine-executable instructions for:
acquiring object identification information of each of a plurality of objects identified to be contained in a video;
acquiring one or more objects capable of audio output from among the identified plurality of objects;
displaying one or more volume adjustment items that correspond to adjusting an audio volume of a particular object from the acquired one or more objects capable of audio output on a display;
adjusting, on one or more speakers, the audio volume of the audio output for at least one specific object from the acquired one or more objects according to an operation command of a respective volume adjustment item from among the one or more volume adjustment items corresponding to the at least one specific object; and
determining that an identified object from the identified plurality of objects is an utterable object from the video based at least in part on determining that the acquired object identification information is included in an object list through a comparison of the object list with the acquired object identification information.

18. The machine-readable non-transitory medium of claim 17, wherein the plurality of objects are detected based at least in part on using an object detection model; and the machine-executable instructions further comprises instructions for acquiring the identification information of each of the plurality of objects by using an object identification model.

19. The machine-readable non-transitory medium of claim 18, where the object detection model and the object identification model correspond to a model trained by deep learning algorithms,
the object detection model is configured to extract a bounding box that represents a shape of the particular object based on image data corresponding to a frame from the video, and
the object identification model is configured to acquire the identification information by identifying the particular object contained in the extracted bounding box.

20. The machine-readable non-transitory medium of claim 17, wherein the one or more objects are acquired by
clustering the acquired plurality of the one or more objects into a plurality of clusters, and
controlling, on the one or more speakers, an audio output contained in a selected cluster from the plurality of clusters.
